(19) United States
(12) Patent Application Publication
(10) Pub. No.: US 2019/0197074 A1
(43) Pub. Date: Jun. 27, 2019

(54) BIG DATA ANALYSIS PLATFORM FOR TRAVEL AND TOURISM

(71) Applicant: OCTRAVES TECHNOLOGY SDN BHD, Kuala Lumpur (MY)

(72) Inventors: Mohammad Tabraiz FEHAM, Kuala Lumpur (MY); Nadeem AHMED, Kuala Lumpur (MY)

(73) Assignee: OCTRAVES TECHNOLOGY SDN BHD, Kuala Lumpur (MY)

(21) Appl. No.: 16/221,503

(22) Filed: Dec. 15, 2018

(30) Foreign Application Priority Data
Dec. 21, 2017 (MY) PI 2017704978

(51) Int. Cl. G06F 16/9536; G06F 16/9537; G06F 16/9538; G06F 16/904

(52) U.S. Cl. CPC G06F 16/9536; G06F 16/9537; G06F 2216/03; G06F 16/904; G06F 16/9538

(57) ABSTRACT

The present invention relates to a computer implemented method for Big Data analysis platform system (100) capable of analyzing big data repository specific for travel and tourism; the said system comprising Data Collection Engine (101); Data Formatting and Mapping Engine (102); Visual Presentation Engine (103); and Sentiment Processing Engine (104) that detects the data in real-time and analyzes the mode of the data which is the tweets, comments and reviews on online social media network i.e. whether the mode of the data is either happy i.e. like, sad i.e. unlike or neutral i.e. no reaction displayed; for providing accurate interpretation of the big data analysis, calculates the sentiment and stores in the database for future queries and analysis detects the data in real-time and determine. The present invention further comprising semantic data model processing system (200) of major features, Country Profiles (201); Flight Fare Prediction (202); Hotel Rates Prediction (203); Global Travel Industry Reports (204); Social Media Mining and Tracking (205); Destination Analytics (206); Global News and Events Monitoring (207); and Traffic Monitoring (208) which will be useful for travel and tourism organization throughout the world.

### FIELD OF INVENTION

The present invention relates to big data platform specifically for travel and tourism industry which is capable to collect, mine and analyse the data across the industry, thereafter processes it to entice meaningful insights and presents it in an intuitive manner for industry stakeholders, policy and decision makers. The present invention comprises following major components; Data Collection Engine which utilizes API connectors, Web Scraping Engine and Machine Data Connectors; Data Formatting and Mapping Engine, Visual Presentation Engine and Sentiment Processing Engine.

### BACKGROUND ART

Tourism industry is so wide and dynamic comprising myriad of elements and components and it is acknowledged as a daunting task for travel and tourism organizations to keep track of entire perspective in real-time with complete monitoring and accurate reporting. Due to increase in worldwide population, coupled with more and more information being created and transmitted; it is a generally accepted fact that data management which in current terminology is known as Big Data analysis is extremely important in many industries. Easy access to smartphones and social media will continuously grow the industry even further as there need to be analytical and interpretation of huge information generated into more meaningful results.

Considering current scenario, social media sites, smartphones, and other consumer devices including PCs and laptops have allowed billions of individuals around the world to contribute to the amount of data obtained and processed in a very large amount. Normally, consumers communicate, browse, buy, share, and search creating large amounts of consumer data. However, conventional techniques in current practice are not able to monitor or analyze this “Big Data.” Generally, conventional modeling techniques do not accommodate for or do not model the properties that define Big Data. For example, conventional techniques may not be able to perform analysis on Big Data because of the sheer number and size of transaction that would be necessary to perform the analysis. Additionally, conventional techniques may consider elements as attributes of the data when, in actual fact, these information are indeed Big Data and such mechanism to analyse these Big Data must be utilized in order to gain meaningful insight into such information.

At present, there is no big data platform for the tourism industry specifically. Companies like IBM and Accenture have solutions specific to the airline industry but again, those are limited and extremely expensive as only the top-tier airlines can afford those platforms. International PCT Publication No. WO2014049378 A1 (hereinafter referred to as '378 Publication) disclosed a method of processing data in a data processing engine in a unified platform system comprising a platform as a service and a software as a service, the method comprising the steps of:

(i) receiving user-defined rules in the data processing engine;

(ii) receiving data in the data processing engine;

(iii) applying in the data processing engine the received user-defined rules to the received data, and

(iv) generating in the data processing engine customized outcomes or actions using the user-defined rules.

An advantage of the method as disclosed in '378 Publication is customization of rules and outcomes or actions as a result of processing data in a data processing engine in a unified platform system, such as the ability to receive a variety of user-defined rules in the data processing engine, where the user-defined rules are then applied to data received in the data processing engine to generate customized outcomes or actions. Nevertheless, '378 Publication did not utilize nor suggest any mechanism for sentiment processing which would have produced more accurate big data analysis.

On the other hand, U.S. Pat. No. 9,031,992 B1 (hereinafter referred to as '992 Patent) discloses a computer implemented method for analyzing a Big Data dataset, the method comprising:

extending a big data model to create representations for the Big Data dataset; wherein the Big Data Model enables analysis of the data in the Big Data dataset; wherein the Big Data Model including a plurality of representations;

using the Big Data model to decouple properties and metadata from the Big Data dataset; wherein each of the properties represent part of the Big Data dataset to enable processing and analysis; wherein the metadata enables calculation of summary information for the Big Data dataset; wherein the representations include meta Information, metadata classification, and metadata content; wherein one or more of the representations of the Big Data Model represents the hierarchy of the data Big Data Dataset; wherein one or more of the representations of the Big Data Model represents the classification of the of the data Big Data Dataset;

performing analysis on the big data dataset by applying a set of analytical tools to the Big Data Model; wherein the analysis further includes pre-analyzing the Big Data Dataset to create further representations and populating the further representations in the Big Data Model based on the pre-analysing. It is to be noted that '992 Patent proposed that the data were mined internally i.e. via unified data mining and processing; and not from multiple of external sources as disclosed in the present invention.

None of the prior art documents discussed above, or other similar disclosures discuss nor suggest big data analysis platform that integrates and aggregates data from various public and proprietary data sources and specifically utilizing Sentiment Processing Engine, processes it to extract meaningful insights and presents it intuitively via dynamic dashboards as described in the present invention. The big data analysis platform disclosed in present invention collects and maintains comprehensive country profiles, crawls and indexes worldwide travel industry reports, historical tourism reports and statistics, destination and attraction insights, real-time twitter data mining and monitoring, real-time overall social media network tracking for a particular destination, real-time traffic analytics, sentiment analysis of travel reviews, twitter and social media feeds, global news and event tracking and more. All of it can be curated and customized to meet destination specific requirements and objectives.

### SUMMARY OF INVENTION

In one aspect of the present invention is related to a computer implemented method for Big Data analysis platform system (100) capable of analyzing big data repository specific for travel and tourism; the said system comprising Data Collection Engine (101); Data Formatting and Mapping Engine (102); Visual Presentation Engine (103) and Sentiment Processing Engine (104) that collects data from various public and proprietary data sources and thereafter processing it into meaningful insights and present it in an intuitive manner via dynamic dashboards.

In another aspect of the present invention further comprises semantic data model processing system (200) of major features such as Country Profiles (201), Flight Fare Prediction (202), Hotel Rates Prediction (203), Global Travel Industry Reports (204), Social Media Mining and Tracking (205), Destination Analytics (206), Global News and Events Monitoring (207) and Traffic Monitoring (208); all of which are inter-related and sourced from various public and proprietary data sources.

The present invention consists of features and a combination of parts hereinafter fully described, it being understood that various changes in the details may be made without departing from the scope of the invention or sacrificing any of the advantages of the present invention.

### BRIEF DESCRIPTION OF THE ACCOMPANYING DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 shows the work flow and components of the big data travel and tourism analysis platform (100) as described in the present invention

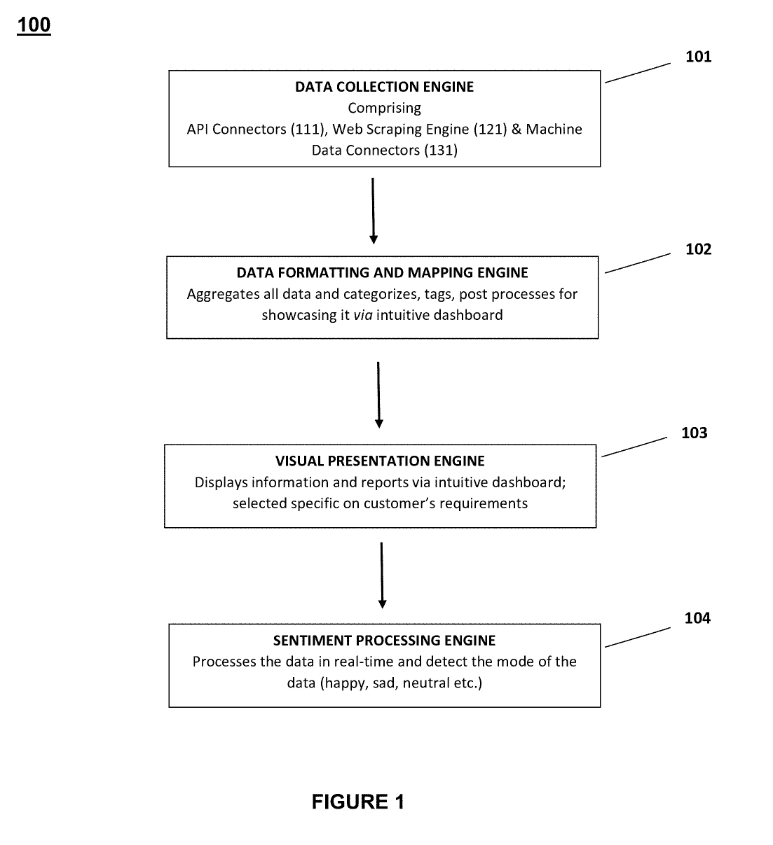

FIG. 2 shows the semantic data model processing system (200) of major features of the present invention; namely Country Profiles (201), Flight Fare Prediction (202), Hotel Rates Prediction (203), Global Travel Industry Reports (204), Social Media Mining and Tracking (205), Destination Analytics (206), Global News and Events Monitoring (207) and Traffic Monitoring (208)

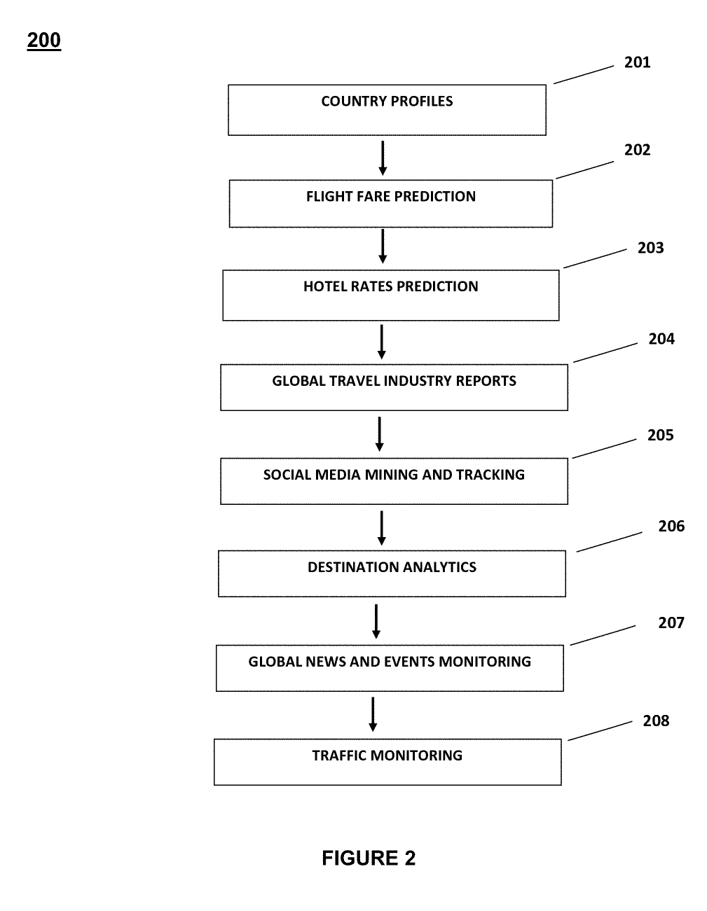

FIG. 3 shows interconnection of all major features of the present invention; data of which are inter-related and sourced from various public and proprietary data sources

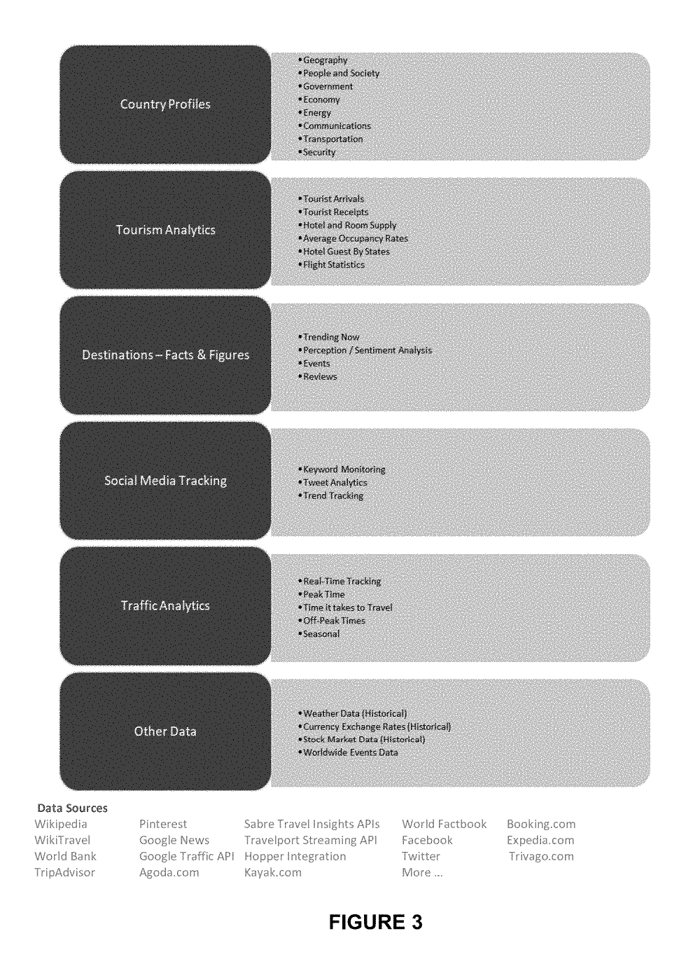

FIG. 4 shows work flow and mechanism of the big data travel and tourism analysis platform as described in the present invention

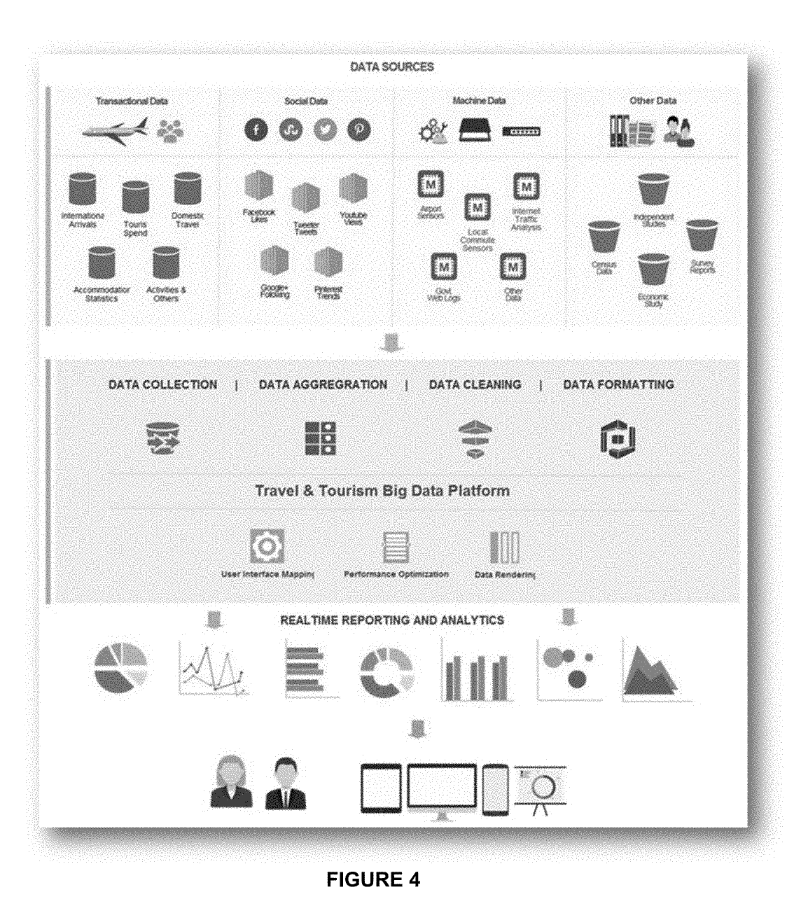

FIG. 5 shows the country profile for Malaysia taking into consideration of travel and tourism analysis based on geography, people and society, government, economy, energy, communications and transportations

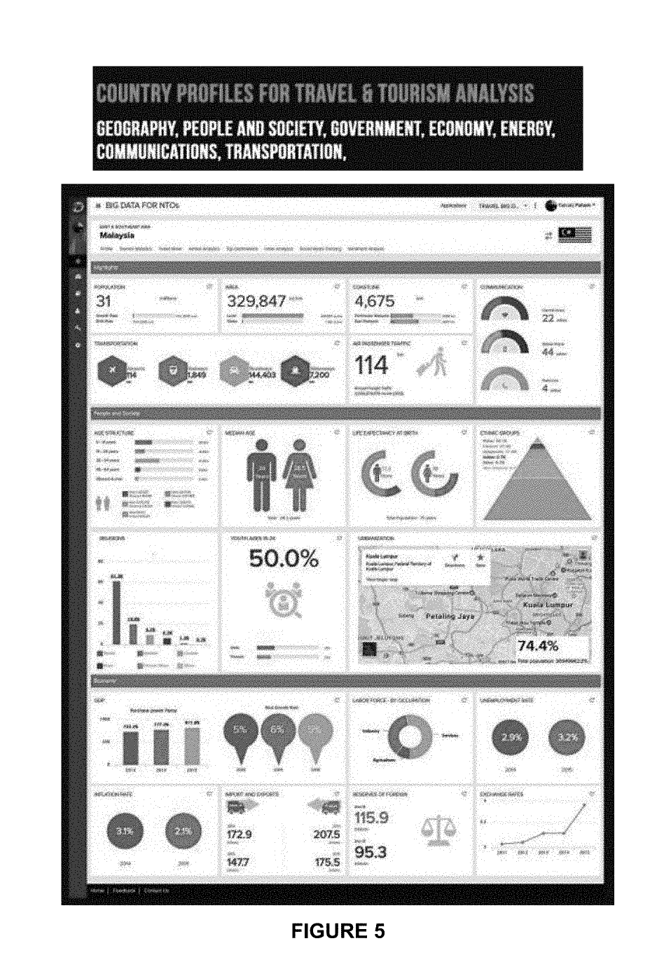

FIG. 6 shows the country profile for China taking into consideration of travel and tourism analysis based on geography, people and society, government, economy, energy, communications and transportations

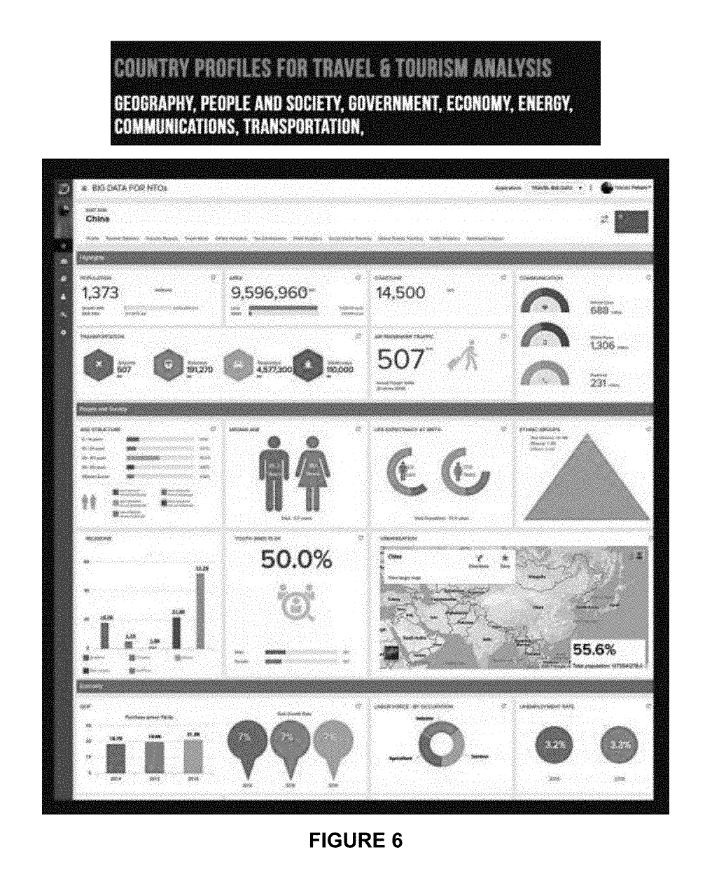

### DETAILED DESCRIPTION OF THE PREFERRED EMBODIMENTS

The present invention relates to big data analysis platform system (100) specifically for travel and tourism industry which is capable to collect, mine and analyse the data across the industry, thereafter processes it to entice meaningful insights and presents it in an intuitive manner via dynamic dashboards for industry stakeholders, policy and decision makers; and specifically, the present invention disclosed a computer implemented method for Big Data analysis platform system (100) capable of analyzing big data repository specific for travel and tourism; the said system comprising
Data Collection Engine (101) that collects the data from all across the web from various public and proprietary data sources;
Data Formatting and Mapping Engine (102) that mines and maps the data constantly so that It can be picked-up by various components on the platform and the data can be showcased via various intuitive dashboards;
Visual Presentation Engine (103) that read the data from the said big data repository and display the information via intuitive dashboards; and
Sentiment Processing Engine (104) that analyzes the mode of the data which is the tweets, comments and reviews on online social media network and various public and proprietary data sources, calculates the sentiment and stores in the database for future queries and analysis.

More elaborately, the present invention comprises the following major components:

Data Collection Engine

The data collection engine is comprised of several sub-components including the following:
API Connectors (111)
Web Scraping Engine (121)
Machine Data Connectors (131)

Each of above sub-components has several nodes and instances to gather specific data. For example, following are some of the major nodes of the web scraping engine which is collecting the data from various websites and portal all across the web:
Web Scraping Engine
   Social Media Scraping
   Facebook
   Twitter
   Instagram
   YouTube
   Daily Motion
   Others
Flight Fares Scraping
   Kayak.com
   SkyScanner.com; and other
Hotels Rates Scraping
   Trivago.com
   Agoda.com
   Booking.com; and other
Other Data Scraping
   Tourism Websites
   Global News and Media; and others

It is worth to note that all of the above data is collected, combined and post-processed for intuitive presentation on dashboard.

Data Formatting and Mapping Engine

The data formatting and mapping engine aggregates all the data and categorizes, tags, post processes for showcasing it via intuitive dashboard and reports.

Visual Presentation Engine

The visual presentation engine displays the information by means of dashboard and reports via intuitive and integrated interface; and the dashboards can be chosen, selected or combined based on specific customer requirements.

Sentiment Processing Engine

The sentiment processing engine processes the data in real-time and is capable to detect the mode of the data; for example:
Twitter Sentiment Analysis
   Detects whether the mode of tweet is happy, sad or neutral
TripAdvisor Reviews Sentiment Analysis
   Detects whether the mode of review is happy, sad or neutral

To be fully functional and capable to utilized in the industry, the embodiment of the present invention must incorporate and be fully integrated with the following major features that involves semantic data model processing:

Country Profiles (201): The country profiles are collected various worldwide creditable data sources and presented in an intuitive dashboard for easy understanding. It allows the user to view the historical tourism perspective like tourism arrival from year to year in a particular country and for example, what is the impact of currency fluctuation on tourism arrivals; or impact of GDP growth rates on tourism etc.

Flight Fare Prediction (202): Based on historical flight fares data mining, the system (200) can predict the fare fluctuations over a period of time; more or less about 6 months. The predictions are presented via an intuitive dashboard.

Hotel Rates Prediction (203): Based on historical hotel rates data mining, the big data analysis platform (100) as disclosed in the present invention coupled with the semantic data model processing system (200) can predict the rate fluctuations over a period of time; more of less about 3 months.

Global Travel Industry Reports (204): big data analysis platform (100) and semantic data model processing system (200) as disclosed in the present invention crawls and aggregates worldwide travel industry related reports and has collected more than 15000 reports and continue to add more in the repository every day.

Social Media Mining and Tracking (205): The global tweet map allows the user to select their destination and immediately gain a perspective that from which regions, countries and cities, people are tweeting about the said destination; and what exactly are they talking about. If the frequency of the tweets is higher from a particular location, the user will see that highlighted in “Red Dot”. All in real-time format. Apart from twitter data mining, big data analysis platform (100) collects and mines the social media network activity from all across the major social networks which includes Google plus, YouTube, DailyMotion, FourSquare, Tumblr, Pinterest, Vimeo, Instagram, Facebook and several other networks; and therefore capable of providing the user real-time and historical snapshot of social media activity for their destination or brand.

Destination Analytics (206): The top destinations and places dashboards, allows the user to analyse and understand the outbound and inbound traffic for that destination in an interactive manner. The user will be able to see where people are travelling and what are the top attractions in a particular city. The user may also view which place is getting the most check-ins and what are the most mentioned terms in a particular city and a lot more of similar nature queries. Some of this data is based on actual booking data from our partners, processing millions of bookings every month. The places and attraction insights, come from our social media data mining platform.

Global News and Events Monitoring (207): The Big Data Platform (100) also enables the user to track the global news and events in real-time. Our platform injects more than 5000 stories, from across the world 24/7. The big data analysis platform (100) as disclosed in the present invention integrates with G DELT, which is a Global Database of Events, Language and Tone. We enable alert generation on specific events in a particular destination, real-time notifications and monitoring. Agencies & companies can utilize our massive data in several ways, suited for tourism management, security and several other perspectives.

Traffic Monitoring (208): the big data analysis platform (100) as disclosed in present invention also provides real-time traffic analytics, traffic movement & flow, travel times, historical hour by hour tracking, peak and off the peak times for major roads, highway tracking on holidays and more. Tourism & destination management companies can use this data; in effective planning and management of a particular destination.

Generally, computers may be used to efficiently process data based on the rules expressed with a programming language (e.g., syntax). Nevertheless, the goals (e.g., syntax) of the computer program may be limited by the constructs or algorithms available. As a solution, graphical user interfaces may allow for presenting powerful visual structures via dashboards for expressing real-world concepts and data in more easily understood formats and meaningful outcome. Specifically, predictive graphs may provide a particularly powerful mechanism for efficiently presenting information obtained from big data repositories with respect to predictive models. As such, big data technologies (e.g., cluster computing frameworks, APIs, graphing tools and interfaces, etc.) may be used to transform big data repositories (e.g., Big Table repositories, etc.) into graph-based data which can now provide a practical mechanism for solving real-world computation problems when dealing with large volumes of data.

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

1. A computer implemented method for Big Data analysis platform system (100) capable of analyzing big data repository specific for travel and tourism; the said system comprising
Data Collection Engine (101) that collects the data from all across the web from various public and proprietary data sources;
Data Formatting and Mapping Engine (102) that mines and maps the data constantly so that It can be picked-up by various components on the platform and the data can be showcased via various intuitive dashboards;
Visual Presentation Engine (103) that read the data from the said big data repository and display the information via intuitive dashboards; and
Sentiment Processing Engine (104) that analyzes the mode of the data which is the tweets, comments and reviews on online social media network and various public and proprietary data sources, calculates the sentiment and stores in the database for future queries and analysis.
wherein the said Sentiment Processing Engine (104) detects the data in real-time and determine whether the mode of the data is either happy i.e. like, sad i.e. unlike or neutral i.e. no reaction displayed; for providing accurate interpretation of the big data analysis.

2. The computer implemented method for Big Data analysis platform system (100) according to claim 1 further comprising semantic data model processing system (200) of major features
Country Profiles (201) wherein country profiles are collected various worldwide creditable data sources and presented in an intuitive dashboard;
Flight Fare Prediction (202) wherein the semantic data model processing system (200) can predict the flight fare fluctuations over a period of time;
Hotel Rates Prediction (203) wherein the semantic data model processing system (200) can predict the hotel rate fluctuations over a period of time;
Global Travel Industry Reports (204) wherein the semantic data model processing system (200) crawls and aggregates worldwide travel industry related reports;
Social Media Mining and Tracking (205) wherein Sentiment Processing Engine (104) of the big data analysis platform system (100) together with the semantic data model processing system (200) collects and mines the social media network activity from all across the major social networks;
Destination Analytics (206) wherein the semantic data model processing system analyses outbound and inbound traffic for particular destination;
Global News and Events Monitoring (207) wherein the big data analysis platform system (100) together with the semantic data model processing system (200) enables the user to track the global news and events in real-time; and
Traffic Monitoring (208) wherein the big data analysis platform (100) together with the semantic data model processing system (200) allows real-time traffic analytics, traffic movement & flow, travel times, historical hour by hour tracking, peak and off the peak times for all major roads and highways.

3. The computer implemented method for Big Data analysis platform system (100) according to claim 1 wherein the said Data Collection Engine (101) comprising
API connectors (111);
Web Scrapping Engine (121); and
Machine Data Connectors (131)
and capable to collect, combine and post process data for presentation on dashboards.

4. The computer implemented method for Big Data analysis platform system (100) according to preceding claims wherein the user can access the post processed information via intuitive dashboards.
